(19) United States
(12) Patent Application Publication
(10) Pub. No.: US 2006/0098715 A1
(43) Pub. Date: May 11, 2006

(54) Method of detecting interference in a frequency hopping wireless communication system

(75) Inventor: Shigeru Amano, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/236,732

(22) Filed: Sep. 28, 2005

(30) Foreign Application Priority Data
Nov. 9, 2004 (JP) 2004-325384

(51) Int. Cl. H04B 1/713

(52) U.S. Cl. 375/132

(57) ABSTRACT

An adaptive frequency hopping wireless communication method in which, upon completion of the transmission of a packet from a transmitting device to a receiving device in a time slot, the transmitting or receiving device (or both) uses the remaining time in the slot, if the amount of remaining time is adequate, to detect interference. Adequate remaining time is recognized from the length of the time slot, minus the length of the packet, minus the time needed to prepare for transmission or reception in the next time slot. This scheme permits frequency channels in which interfering signals are present and frequency channels in which interfering signals are absent to be detected quickly so that use of these frequency channels can be promptly discontinued or resumed.

### BACKGROUND OF THE INVENTION

1. Field of the Invention

This invention relates to an adaptive frequency hopping wireless communication method, more particularly to the detection of interfering signals.

2. Description of the Related Art

Frequency hopping spread spectrum (FH-SS) wireless communication systems are used in the industrial, scientific, and medical (ISM) radio bands to reduce interference from other devices and communication systems. Nevertheless, interference from direct sequence spread spectrum (DS-SS) communication devices and devices such as microwave ovens remains a problem, degrading service in the FH-SS system and sometimes the interfering system as well. Adaptive frequency hopping systems that detect interfering signals and avoid the frequency channels in which interference is detected are also known, but the method of detecting and avoiding interference is implementation-dependent and has not been standardized.

Interference in frequency channels actually being used for communication can be detected from reception status parameters such as the data transfer rate, packet error rate, and received signal strength indicator (RSSI).

Once interference has been detected in a frequency channel, the channel is temporarily taken out of service by removing it from the frequency hop sequence. To enable a channel to be returned to service, it is necessary to detect interference in frequency channels not currently included in the hop sequence and decide whether each channel should remain outside the hop sequence or be reinstated.

One method of detecting interference in out-of-service channels is to use unoccupied time slots. For example, Japanese Patent Application Publication No. 11-355840 discloses a frequency hopping system in which a base (master) station communicates with a plurality of terminal (slave) stations in assigned time slots. To facilitate operation, administration, and maintenance of the system, one or more time slots are specifically reserved for interference detection. A station can monitor the received signal level in the reserved slots to determine the interference level in different frequency channels.

This method is generally known as carrier sense: the wireless communication device is set to the frequency of the channel to be checked, a receiving window is opened, and the received electric field is measured. If unoccupied time slots are available, the carrier sense method can be used to assess all frequency channels, including both used and unused channels, on an equal basis and classify them as good or bad.

To use unoccupied time slots to check interference, however, a communication device must know in advance which time slots are unoccupied; that is, it must know the transmitting timing of other devices in the communication system. In a communication system having a network comprising master and slave devices, the master device allocates time slots to the slave devices. Only the master device knows which slots are unoccupied, so the master device must be relied on to detect interference.

One resulting problem is that once a frequency channel has been excluded from service, interference in that channel is detected by only a single device, which makes the detection process less reliable. Another problem is that detection of interference takes time, since a single device must monitor all unused channels one at a time, using the limited number of unoccupied time slots.

### SUMMARY OF THE INVENTION

An object of the present invention is to provide a faster and more reliable method of detecting interference in an adaptive frequency hopping communication system.

In the invented adaptive frequency hopping wireless communication method, upon completion of the transmission of a packet from a transmitting device to a receiving device in a time slot, the transmitting device or receiving device (or both) decides whether or not to detect interference by comparing a quantity A minus B minus C with a threshold value. A is the time slot length; B is the time needed to prepare for the next time slot; C is the length of the packet, that is, the time from the beginning of the time slot in which the packet was transmitted or received to the end of the packet. A decision to detect interference is made if this quantity (A−B−C) exceeds the threshold value. If certain types of packets satisfying the threshold condition are known in advance, the decision may be made according to the type of packet transmitted or received.

The invented method enables the transmitting and receiving devices to detect interference for themselves by using the remaining time in their own time slots, without having to wait for an unoccupied time slot or rely on a master device.

### BRIEF DESCRIPTION OF THE DRAWINGS

In the attached drawings:

FIG. 1 is a timing waveform diagram illustrating packet transmission in time slots;

FIG. 2 is a flowchart illustrating the operation of a transmitting device according to a first embodiment of the invention;

FIG. 3 is a flowchart illustrating the operation of a receiving device according to the first embodiment of the invention;

FIG. 4 is a flowchart illustrating the operation of a transmitting device according to a second embodiment of the invention; and

FIG. 5 is a flowchart illustrating the operation of a receiving device according to the second embodiment of the invention.

### DETAILED DESCRIPTION OF THE INVENTION

Embodiments of the invention will now be described with reference to the attached drawings, in which like elements are indicated by like reference characters.

### First Embodiment

In the first embodiment, whether to detect interference is determined from the time remaining in the current time slot and the time needed to prepare for the next time slot. This preparation time is, for example, the lock acquisition time of a phase-locked loop in the transmitting or receiving device.

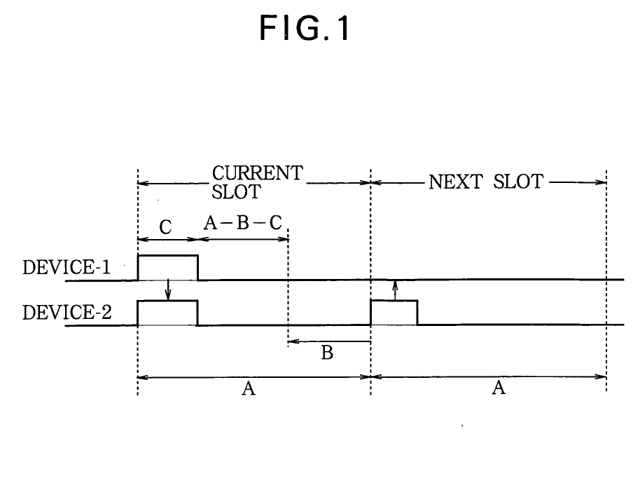

In FIG. 1, A indicates the time slot length; B indicates the time needed to prepare for the next time slot; C indicates the length of a packet transmitted from one device (device-1) to another device (device-2), that is, the time from the beginning of the time slot until device-1 completes transmission of the packet. If the time calculated by the formula (A−B−C) exceeds a predetermined threshold value, device-1 has adequate time to detect interference in the remaining part of the current time slot.

Since device-2 operates in a corresponding receiving time slot, it can decide whether to detect interference by the same criterion (A−B−C), except that C represents the time from the beginning of the time slot until device-2 finishes receiving the packet.

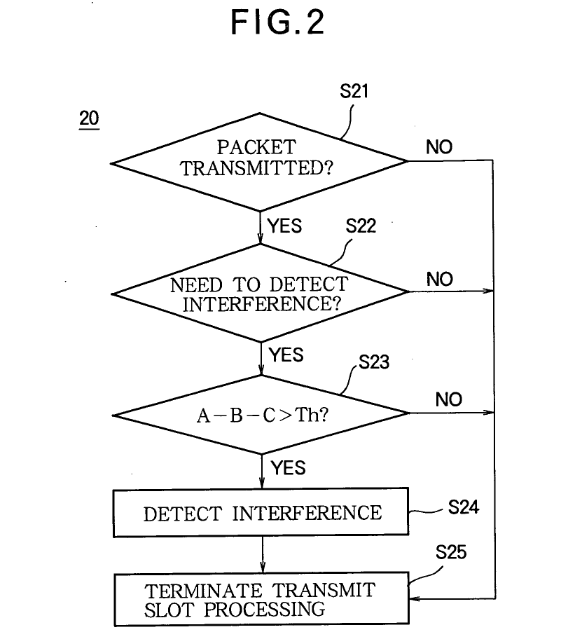

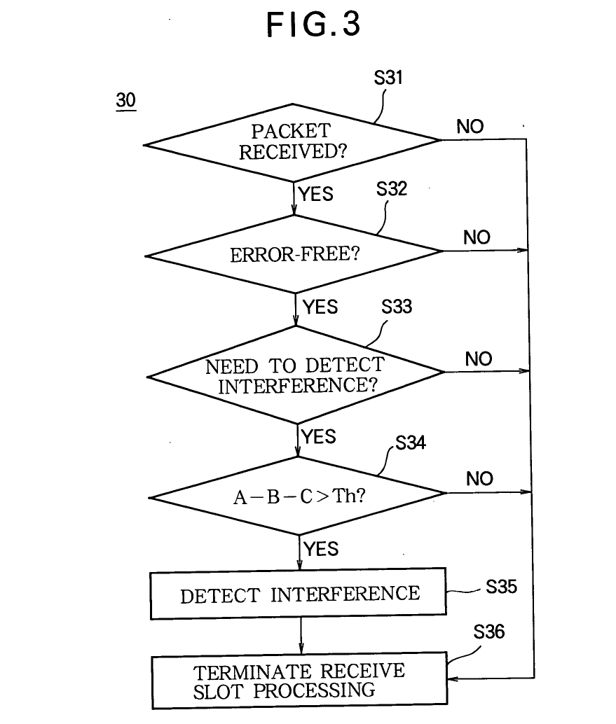

Transmitting operations 20 and receiving operations 30 in a given time slot take place as shown in FIGS. 2 and 3.

Referring to FIG. 2, first, in step S21, the transmitting device decides whether it can use the present time slot to transmit packet data. If so, the transmitting process proceeds to step S22. Otherwise, the process proceeds to step S25 and the transmitting operation terminates.

In step S22, the transmitting device decides whether there is any need to detect interference. If so, the transmitting process proceeds to step S23. Otherwise, the process proceeds to step S25 and the transmitting operation terminates.

In step S23, upon completion of the transmission of the packet data, the transmitting device decides whether adequate time for detecting interference remains in the time slot or not. If the quantity (A−B−C) indicated in FIG. 1 exceeds a predetermined threshold value (Th), enough time remains, interference detection is performed by the carrier sense method in step S24, and the transmitting operation ends in step S25. If the above quantity (A−B−C) is less than or equal to the threshold value (Th), interference detection is not carried out in the current time slot and the transmitting operation terminates forthwith in step S25.

When interference detection is performed in step S24, the transmitting device may switch to the frequency of a channel currently excluded from the frequency hop sequence, to determine whether interference is still present or not. Alternatively, the transmitting device may continue operating at the same frequency, to determine whether interference is present or not in the frequency channel in which it has just transmitted a packet. If interference is detected, the channel can be removed from the set of channels available for frequency hopping.

Referring to FIG. 3, in step S31, if a receiving device has received packet data in a receiving time slot, the receiving process proceeds to step S32. Otherwise, the process proceeds to step S36 and the receiving operation terminates.

In step S32, the receiving device decides whether any reception errors have been detected in the received packet data. If no errors are detected, the receiving process proceeds to step S33. Otherwise, the process proceeds to step S36 and the receiving operation terminates.

The reason for terminating the receiving procedure without detecting interference if an error is detected in step S32 is that the packet length field or packet type field may have been received incorrectly. Consequently, the transmitting device may continue the transmitting operation even after the receiving device has completed the receiving operation, particularly if the transmitting device is a master device and the receiving device is a slave device. Restricting the carrier sense procedure to the remaining time following error-free packet reception ensures that any detected signal will actually be interference and not an unanticipated continuation of packet transmission.

In step S33, if the receiving device decides whether there is any need to detect interference. If so, the receiving process proceeds to step S34. Otherwise, the process proceeds to step S36 and the receiving operation terminates.

In step S34, upon completion of the reception of the data, the receiving device decides whether adequate time for detecting interference remains in the time slot or not. If the quantity (A−B−C) indicated in FIG. 1 (in this case, C is the time until completion of reception) exceeds a threshold value (Th), interference detection is performed in step S35 and the receiving operation terminates in step S36. In step S34, if the quantity (A−B−C) is less than or equal to the threshold value (Th), interference detection is not carried out in the current time slot and the receiving operation terminates in step S36.

Like a transmitting device, a receiving device may continue operating at the same frequency, to detect interference in the channel in which it has just received a packet, or switch to the frequency of an unused channel, to detect interference in a channel currently excluded from the frequency hop sequence.

The results of interference detection can be used to decide which frequency channels should be removed from the current hop sequence and which presently unused channels are available to take the place of the removed channels. The decision as to whether to exclude a channel from the hop sequence or return an excluded channel to the hop sequence is preferably based on detection of interference or the absence of interference in a plurality of time slots, or by a plurality of devices. In a master-slave system, for example, the master device may collect interference information from a plurality of slave devices to decide which channels to exclude from or return to active service.

As described above, according to the first embodiment, interference can be detected whenever sufficient time remains in a transmitting or receiving time slot, regardless of whether unoccupied time slots are available or not. In a network system having a master-slave architecture, interference can be detected both by the master device, which controls the time slot assignments, and the slave devices, which do not control the time slot assignments. Interference can therefore be detected faster than in a system relying on the master device alone, and more information can be obtained, which improves the reliability of the system.

### Second Embodiment

The second embodiment decides whether or not to detect interference according the type of packet transmitted. Interference is detected if a transmitted or received packet is a type of packet that satisfies the threshold condition given above (A−B−C>Th), without actual testing of this condition by explicit calculation.

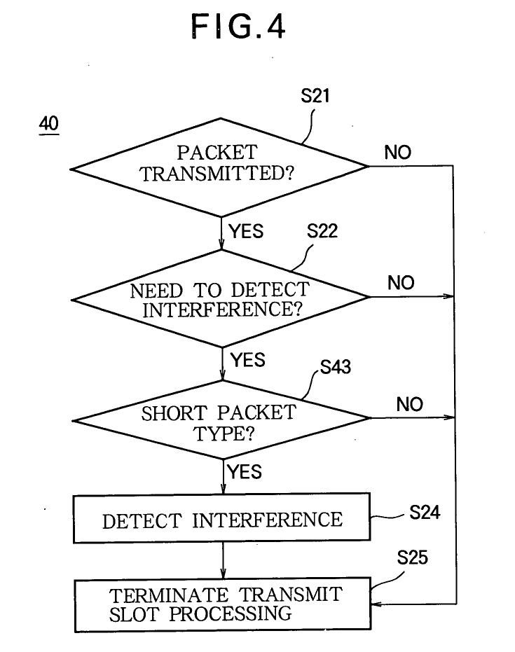

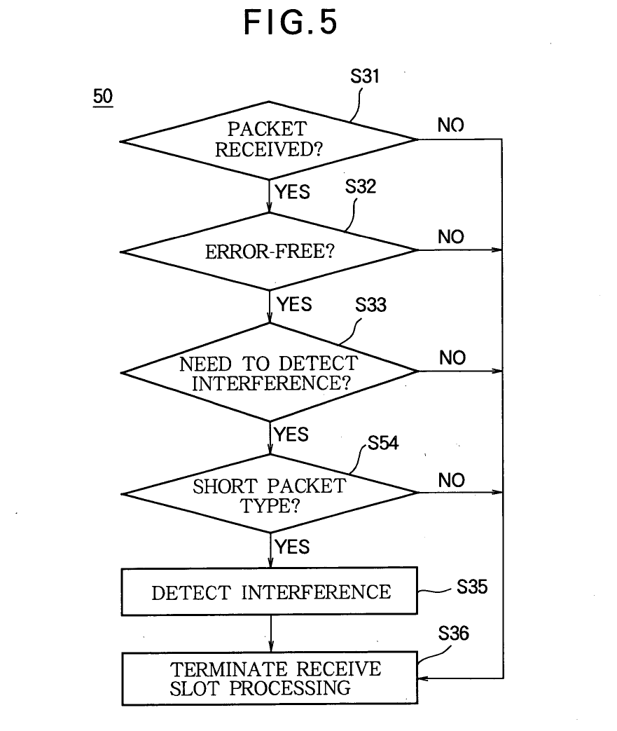

Transmitting operations 40 and receiving operations 50 in the second embodiment take place as shown in FIGS. 4 and 5.

Referring to FIG. 4, when a transmitting device sends a packet, instead of testing a threshold condition (A−B−C>Th) as in step S23 in the first embodiment, the device simply decides whether the packet is a type of packet that is known to be short enough to satisfy this condition (step S43). For example, a Bluetooth Null packet (126 bits) and various other types of Bluetooth packets may be known to satisfy the threshold condition. (Bluetooth designates a short-range frequency hopping radio communication technology and is a registered trademark of the Bluetooth Special Interest Group.)

The other steps in FIG. 4 are the same as in FIG. 2.

Referring to FIG. 5, when a receiving device finishes receiving a packet without error, the receiving device decides whether the packet is a type of packet known to be short enough to satisfy the threshold condition required for detecting interference (step S54). The other steps in FIG. 5 are the same as in FIG. 3.

Like the first embodiment, the second embodiment enables interference to be detected regardless of whether or not unoccupied time slots are present. In addition, the second embodiment can be implemented with less hardware, because it is not necessary to perform a threshold calculation to decide whether the remaining time in a time slot is sufficient for detecting interference. This is particularly beneficial when the invented method is practiced in portable wireless systems.

The second embodiment is applicable in communication systems that transmit known types of packets, at least some of which are short enough to leave adequate time for detecting interference.

Those skilled in the art will recognize that modifications of the above embodiments are possible within the scope of the invention, which is defined in the appended claims.

What is claimed is:

1. A wireless communication method using adaptive frequency hopping to transmit packets from a transmitting device to a receiving device in predetermined time slots, wherein upon completion of transmission of a packet in a time slot, a remaining part of the time slot is used to detect interference, provided the remaining part has adequate length as determined from a length of the time slot, a length of the packet, and a time needed to prepare for a next time slot.

2. The wireless communication method of claim 1, wherein the transmitting device decides whether or not to detect interference in the remaining part of the time slot by comparing a quantity A minus B minus C (A−B−C) with a threshold value, where A is the length of the time slot, B is the time needed to prepare for the next time slot, and C is a time from the beginning of the time slot to the end of the packet.

3. The wireless communication method of claim 2, wherein the transmitting device detects interference if the quantity (A−B−C) is greater than the threshold value.

4. The wireless communication method of claim 3, wherein types of packets for which the quantity (A−B−C) is greater than the threshold are known in advance, and the transmitting device decides whether or not to detect interference according to the type of packet transmitted.

5. The wireless communication method of claim 2, wherein after transmitting a packet at one frequency in a time slot, the transmitting device switches to a different frequency to detect interference in the remaining part of the time slot.

6. The wireless communication method of claim 2, wherein after transmitting a packet at one frequency in a time slot, the transmitting device detects interference at the same frequency in the remaining part of the time slot.

7. The wireless communication method of claim 1, wherein upon completion of reception of the packet, if the reception is error-free, the receiving device decides whether or not to detect interference in the remaining part of the time slot by comparing a quantity A minus B minus C (A−B−C) with a threshold value, where A is the length of the time slot, B is the time needed to prepare for the next time slot, and C is a time from the beginning of the time slot to the end of the packet.

8. The wireless communication method of claim 7, wherein the receiving device detects interference if the quantity (A−B−C) is greater than the threshold value.

9. The wireless communication method of claim 8, wherein types of packets for which the quantity (A−B−C) is greater than the threshold are known in advance, and the receiving device decides whether or not to detect interference according to the type of packet received.

10. The wireless communication method of claim 7, wherein after receiving a packet at one frequency in a time slot, the receiving device switches to another frequency to detect interference in the remaining part of the time slot.

11. The wireless communication method of claim 7, wherein after receiving a packet at one frequency in a time slot, the receiving device detects interference at the same frequency in the remaining part of the time slot.
